(19) United States
(12) Patent Application Publication
(10) Pub. No.: US 2025/0240548 A1
(43) Pub. Date: Jul. 24, 2025

(54) DETECTION DEVICE AND DETECTION SYSTEM

(71) Applicant: CANON KABUSHIKI KAISHA, Tokyo (JP)

(72) Inventors: HIROAKI KAMEYAMA, Kanagawa (JP); YU ARISHIMA, Kanagawa (JP); MASANORI SHIBATA, Tokyo (JP); KOICHIRO IWATA, Kanagawa (JP)

(21) Appl. No.: 19/027,216

(22) Filed: Jan. 17, 2025

(30) Foreign Application Priority Data
Jan. 18, 2024 (JP) 2024-006213

(51) Int. Cl. H04N 25/78

(52) U.S. Cl. CPC H04N 25/78

(57) ABSTRACT

A detection device includes a pixel including a photodiode, an amplification transistor having a gate connected to an output node of the photodiode, a reset transistor configured to reset the photodiode, and a selection transistor; a signal line connected to the pixel; and a readout circuit configured to read out a signal from the pixel via the signal line, wherein the readout circuit includes an A/D converter configured to A/D-convert the signal input from the pixel via the signal line, and the A/D converter performs an offset cancellation operation of holding a signal level corresponding to a signal generated by the photodiode while canceling an offset of the A/D converter, and performs first A/D conversion for a change of the signal level obtained after the offset cancellation operation.

### BACKGROUND

### Technical Field

The present disclosure relates to a detection device and a detection system.

### Description of the Related Art

There is provided a technique of converting an analog signal output from a pixel into a digital signal by an analog-to-digital converter (to be referred to as an A/D converter hereinafter). Japanese Patent Laid-Open No. 2001-128070 describes that a pixel is reset to perform A/D conversion after reading out a signal from the pixel. Furthermore, Japanese Patent Laid-Open No. 2001-128070 describes that an offset of a comparator is canceled during a period in which the pixel is reset.

In a configuration described in Japanese Patent Laid-Open No. 2001-128070, A/D conversion is performed after resetting a pixel. Therefore, a signal on which noise of the AD converter, for example, noise in an offset cancellation operation of the comparator is superimposed is A/D-converted. Thus, Japanese Patent Laid-Open No. 2001-128070 has room to reduce noise.

### SUMMARY

The present disclosure provides a technique advantageous in detecting, with low noise, a signal generated by a pixel.

A first aspect of the present invention provides a detection device comprising: a pixel including a photodiode, an amplification transistor having a gate connected to an output node of the photodiode, a reset transistor configured to reset the photodiode, and a selection transistor; a signal line connected to the pixel; and a readout circuit configured to read out a signal from the pixel via the signal line, wherein the readout circuit includes an A/D converter configured to A/D-convert the signal input from the pixel via the signal line, and the A/D converter performs an offset cancellation operation of holding a signal level corresponding to a signal generated by the photodiode while canceling an offset of the A/D converter, and performs first A/D conversion for a change of the signal level obtained after the offset cancellation operation.

A second aspect of the present invention provides a detection device comprising: a pixel including a photodiode configured to receive radiation, an amplification transistor having a gate connected to an output node of the photodiode, a reset transistor configured to reset the photodiode, and a selection transistor; a signal line connected to the pixel; and a readout circuit configured to read out a signal from the pixel via the signal line, wherein the readout circuit includes an A/D converter configured to A/D-convert the signal input from the pixel via the signal line, the A/D converter includes a differential amplification circuit including an input node and an output node, a capacitive element having one terminal connected to the input node and the other terminal connected to the signal line, and a switch connected to the one terminal, the switch transitions from an ON state to an OFF state during a period in which a first signal having a signal level corresponding to a dose of the radiation received by the photodiode is output to the one terminal, a second signal having a signal level corresponding to a reset level of the gate is output to the one terminal during a period until the switch changes from the OFF state to the ON state again, and the A/D converter performs A/D conversion during a period in which the second signal is output to the one terminal.

Further features of the present invention will become apparent from the following description of exemplary embodiments with reference to the attached drawings.

### BRIEF DESCRIPTION OF THE DRAWINGS

FIG. 1 is a block diagram showing an example of the configuration of a detection device formed as a solid-state imaging device;

FIG. 2 is a circuit diagram showing an example of the configuration of a pixel and a readout circuit in the detection device according to the first embodiment;

FIG. 3A is a timing chart showing the first operation example of the detection device according to the first embodiment;

FIG. 3B is a timing chart showing the second operation example of the detection device according to the first embodiment;

FIG. 4 is a timing chart showing an operation example of a clip circuit;

FIG. 5 is a circuit diagram showing an example of the configuration of a pixel and a readout circuit in a detection device according to the second embodiment;

FIG. 6 is a timing chart showing an operation example of the detection device according to the second embodiment;

FIG. 7 is a view showing a detection system according to the third embodiment; and

FIGS. 8A and 8B are views each showing a detection system according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

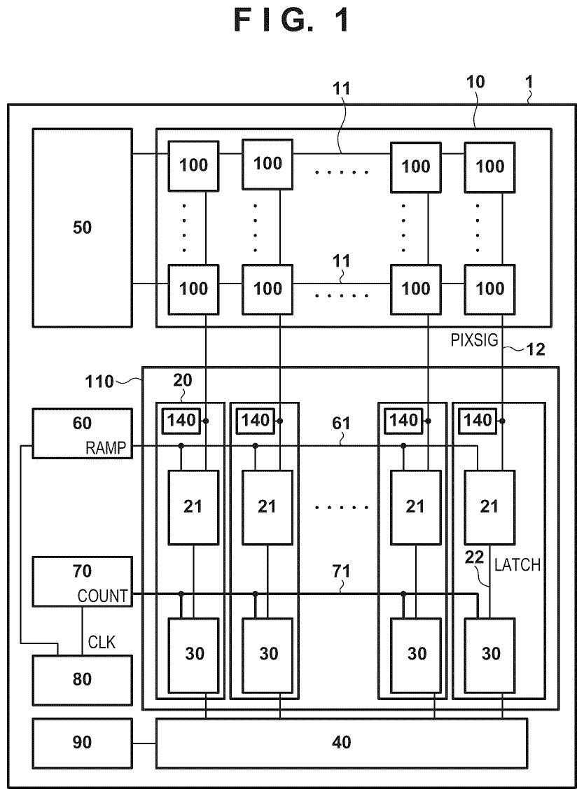

FIG. 1 shows the configuration of a detection device 1 according to an embodiment. FIG. 1 exemplifies the detection device 1 formed as a solid-state imaging device including a plurality of pixels but the detection device 1 can be formed as a device including at least one pixel (or detection element). The detection device 1 is a direct conversion type detection device including a photodiode that directly converts incident radiation into electric charges. In the following description, “radiation” is a concept including non-ionizing radiation (infrared rays, visible light, ultraviolet rays, or the like) and ionizing radiation (electromagnetic radiation and particle radiation). The electromagnetic radiation is a concept including, for example, X-rays and γ-rays, and the particle radiation is a concept including, for example, an electron beam, a proton beam, a neutron beam, and α-rays. The “detection system” indicates a general system that acquires, as electronic data, an image of an imaging target (an object, for example, a patient for a medical detection system) using radiation. The “image” may be a till image or a moving image.

The detection device 1 can include, for example, a pixel array 10, a readout circuit 110, a horizontal scanning circuit 40, a vertical scanning circuit 50, a ramp signal generation circuit 60, a counter 70, a timing control unit 80, and a signal processing unit 90. The detection device 1 can further include a plurality of row control line groups 11, a plurality of signal lines 12, a ramp signal line 61, and a count signal line 71.

The pixel array 10 includes a plurality of pixels 100 arranged to form a plurality of rows and a plurality of columns. The vertical scanning circuit 50 is electrically connected to the plurality of pixels 100 via the plurality of row control line groups 11 on the row basis. One row control line group 11 is commonly provided in correspondence with the pixels 100 of one row. One row control line group 11 can include a selection signal line for transmitting a selection signal and a reset signal line for transmitting a reset signal. The vertical scanning circuit 50 is electrically connected to the timing control unit 80.

The vertical scanning circuit 50 controls the plurality of pixels 100 on the row basis based on a timing signal supplied from the timing control unit 80. The pixel 100 of each column on the row selected by the vertical scanning circuit 50 outputs a signal PIXSIG to the corresponding signal line 12 among the plurality of signal lines 12. Each of the plurality of signal lines 12 is connected to the pixels 100 of the plurality of rows located on the corresponding column.

The ramp signal generation circuit 60 generates a ramp signal RAMP and supplies it to a plurality of A/D converters 21 via the ramp signal line 61. Based on a timing signal supplied from the timing control unit 80, the ramp signal generation circuit 60 can start an operation of changing the signal level of the ramp signal RAMP with the lapse of time.

The readout circuit 110 includes a plurality of column circuits 20 respectively corresponding to the plurality of columns each formed by the plurality of pixels 100. Each column circuit 20 can include the A/D converter 21, a column memory 30, a clip circuit 140, and a latch signal line 22. Each column circuit 20 may include, for example, a sample and hold circuit and an amplification circuit at the preceding stage of the A/D converter 21.

The clip circuit 140 clips the voltage of the signal line 12. The A/D converter 21 can be connected to the column memory 30 by the latch signal line 22. Each signal line 12 receives, from the pixel 100 connected to the signal line 12, the signal PIXSIG (first signal) having a signal level corresponding to the signal generated by the photodiode. The A/D converter 21 can output, to the corresponding column memory 30, a comparison result signal LATCH indicating a result of comparing, with the ramp signal RAMP, the signal level of the signal PIXSIG output from each pixel 100 of the corresponding column to the signal line 12.

The counter 70 counts a clock signal CLK supplied from the timing control unit 80 to generate a count signal COUNT. The counter 70 supplies the count signal COUNT to the plurality of column memories 30 via the count signal line 71. The count signal COUNT is a digital signal of a plurality of bits. The count signal line 71 typically includes a plurality of bit lines each for transmitting a 1-bit signal, and parallelly transmits the signal of the plurality of bits of the count signal COUNT.

The horizontal scanning circuit 40 sequentially selects the column memories 30 of the plurality of columns. The column memory 30 selected by the horizontal scanning circuit 40 outputs, to the signal processing unit 90, a digital signal corresponding to the voltage of the signal level of the signal PIXSIG. The signal processing unit 90 performs various processes such as correction, amplification, and a level shift for the digital signal input from the column memory 30, and outputs the thus obtained signal to the outside of the detection device 1.

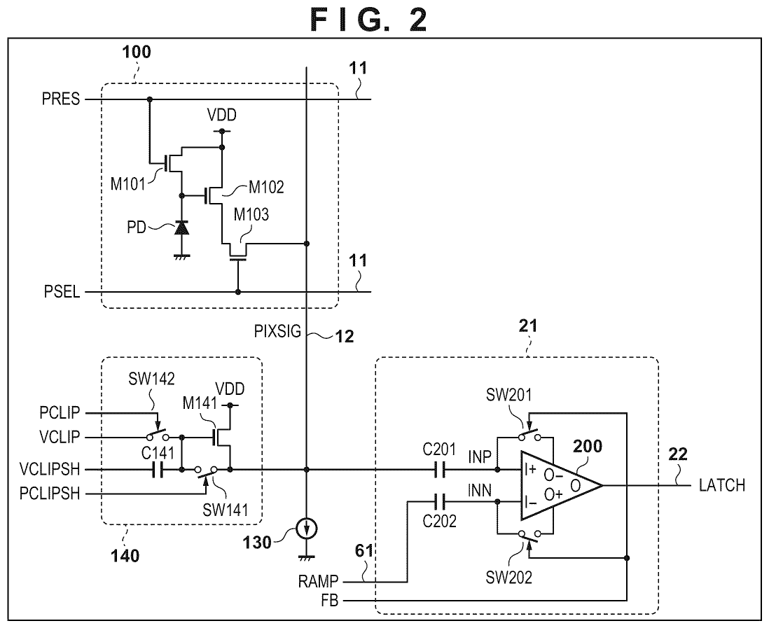

FIG. 2 shows an example of the configuration of one pixel 100 and part (the A/D converter 21 and the clip circuit 140) of the readout circuit 110 (more specifically, the column circuit 20 connected to the pixel 100) as the configuration of the detection device 1 according to the first embodiment. The pixel 100 can include a photodiode PD, an amplification transistor M102 having a gate connected to the output node of the photodiode PD, a reset transistor M101 configured to reset the photodiode PD, and a selection transistor M103. The amplification transistor M102, the reset transistor M101, and the selection transistor M103 can be formed by MOS transistors. The row control line group 11 and the signal line 12 can be connected to the pixel 100. The row control line group 11 can include a reset signal line for transmitting a reset signal PRES and a selection signal line for transmitting a selection signal PSEL. The signal line 12 is connected to a current source 130, and supplies, to the column circuit 20 of the readout circuit 110, more specifically, the A/D converter 21, the signal PIXSIG having the signal level corresponding to the signal (a dose of radiation received by the photodiode PD) generated by the photodiode PD.

The amplification transistor M102 can have a drain connected to a power supply VDD, a gate connected to the cathode of the photodiode PD, and a source connected to the signal line 12. The selection transistor M103 can have a source connected to the signal line 12, a drain connected to the source of the amplification transistor M102, and a gate connected to the selection signal line for transmitting the selection signal PSEL. Alternatively, the selection transistor M103 may be arranged in a path that connects the power supply VDD and the amplification transistor M102.

The reset transistor M101 can have a drain connected to the power supply VDD, a source connected to the cathode of the photodiode PD, and a gate connected to the reset signal line for transmitting the reset signal PRES. The anode of the photodiode PD is connected to a reference voltage (GND). The amplification transistor M102 outputs, to the signal line 12, the signal PIXSIG having the signal level corresponding to the signal generated by the photodiode PD, that is, the signal (potential) appearing at the output node (cathode) of the photodiode PD. The amplification transistor M102 performs a source follower operation in accordance with a current supplied from the current source 130 connected to the signal line 12 and the voltage VDD connected to the drain.

The detection device 1 is not limited to a solid-state imaging device or a CMOS sensor in which the pixel 100 is irradiated with light, and may be formed as, for example, an electron beam direct detection device in which the pixel 100 is irradiated with an electron beam. It is known that the characteristic of each MOS transistor of the pixel 100 deteriorates due to a threshold shift or the like in proportion to the irradiation time of an electron beam. Therefore, the number of MOS transistors forming the pixel 100 is desirably small. In an example, the pixel 100 can be formed by the above three MOS transistors.

The A/D converter 21 can be formed by, for example, a comparator. The comparator formed as the A/D converter 21 can include, for example, a differential amplification circuit 200, capacitors C201 (capacitive element) and C202, and switches SW201 and SW202. The differential amplification circuit 200 includes a noninverting input node (I+) as the first input node, an inverting input node (I−) as the second input node, a noninverting output node (O+) as the first output node, and an inverting output node (O−) as the second output node. The first input node and the first output node are in phase, and the second input node and the second output node are in phase. The first input node and the second input node form a differential input pair, and the first output node and the second output node form a differential output pair. The differential amplification circuit 200 can be a fully differential amplification circuit. The differential amplification circuit 200 further includes an output node (O) for outputting a result of comparing a voltage applied to the first input node and a voltage applied to the second input node.

The noninverting input node (I+) of the differential amplification circuit 200 is connected to the second terminal (one terminal) of the first capacitor C201 and the first terminal of the switch SW201 via a signal line INP. The first terminal (the other terminal) of the first capacitor C201 is connected to the signal line 12. The second terminal of the first switch SW201 is connected to the inverting output node (−) of the differential amplification circuit 200. The first switch SW201 can be understood as a switch that short-circuits the noninverting input node (I+) as the first input node of the differential amplification circuit 200 and the inverting output node (O−) as the second output node of the differential amplification circuit 200. The first switch SW201 is controlled by a control signal FB from the timing control unit 80.

The inverting input node (−) of the differential amplification circuit 200 is connected to the second terminal of the second capacitor C202 and the second terminal of the second switch SW202 via a signal line INN. The first terminal of the second capacitor C202 is connected to the ramp signal line 61, and receives the ramp signal RAMP. The second terminal of the second switch SW202 is connected to the noninverting output node (+) of the differential amplification circuit 200. The second switch SW202 can be understood as a switch that short-circuits the inverting input node (I−) as the second input node of the differential amplification circuit 200 and the noninverting output node (O+) as the first output node of the differential amplification circuit 200. The second switch SW202 is controlled by the control signal FB from the timing control unit 80.

An offset can be canceled by controlling the switches SW201 and SW202. An offset cancellation operation is an operation of holding the signal level of the signal PIXSIG output to the signal line 12 in accordance with the signal generated by the photodiode PD of the pixel 100 while canceling the offset of the A/D converter 21. After performing the offset cancellation operation, the A/D converter 21 A/D-converts the change of the signal level obtained after the offset cancellation operation. The output node (O) of the differential amplification circuit 200 is connected to the latch signal line 22, and outputs the comparison result signal LATCH. The comparison result signal LATCH indicates the result of comparing, with the ramp signal RAMP, the signal level of the signal PIXSIG output to the signal line 12.

Note that the differential amplification circuit 200 may include an inverting input node (I−) as the first input node, a noninverting input node (IO) as the second input node, an inverting output node (O−) as the first output node, and a noninverting output node (O+) as the second output node.

Furthermore, the A/D converter 21 is not limited to the above-described configuration as long as it can hold (as an initial value) the voltage of the level of the signal PIXSIG (and the ramp signal RAMP) while canceling the offset of the A/D converter 21.

The clip circuit 140 can include, for example, a clip transistor M141 formed by a MOS transistor, switches SW141 and SW142, and a capacitor C141. The clip circuit 140 is not limited to the configuration exemplified in FIG. 2 as long as it is configured to execute a clip operation of limiting the amplitude of the signal PIXSIG to a predetermined range. Assume here that a voltage drop by the threshold voltage of the clip transistor M141 is negligible. The clip circuit 140 clips or limits the voltage of the signal line 12 in accordance with the gate voltage of the clip transistor M141.

The clip transistor M141 has a source connected to the signal line 12 and the switch SW141, and a drain connected to the power supply VDD. The gate of the clip transistor M141 is connected to the first terminal of the switch SW141, the second terminal of the switch SW142, and the second terminal of the capacitor C141. A first voltage VCLIPSH is supplied to the first terminal of the capacitor C141. A second voltage VCLIP is supplied to the first terminal of the switch SW142. The first voltage VCLIPSH and the second voltage VCLIP may be supplied from the outside of the detection device 1 or may be generated in the detection device 1. A first signal PCLIP is supplied from the timing control unit 80 to the control terminal of the switch SW142. A second signal PCLIPSH is supplied from the timing control unit 80 to the control terminal of the switch SW141.

In a case where the second signal PCLIPSH is at high level, the switch SW141 is set in a conductive state, thereby sampling the signal PIXSIG in the capacitor C141. If the second signal PCLIPSH transitions from high level to low level, the switch SW141 transitions from the conductive state to a nonconductive state, and holds the signal PIXSIG sampled in the capacitor C141. By changing the first voltage VCLIPSH as a first voltage V in a state in which the switch SW141 is in the nonconductive state, it is possible to control the gate voltage of the clip transistor M141. In a case where the first signal PCLIP is at high level, the switch SW142 is set in the conductive state, thereby supplying the second voltage VCLIP to the gate of the clip transistor M141. The switch SW142 needs to be set in the conductive state while the switch SW141 is in the nonconductive state.

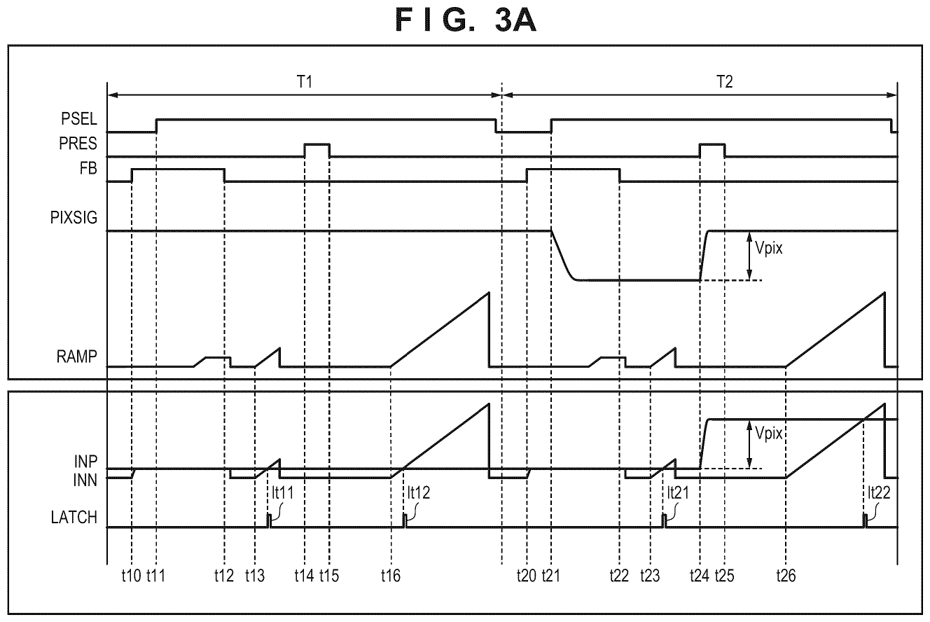

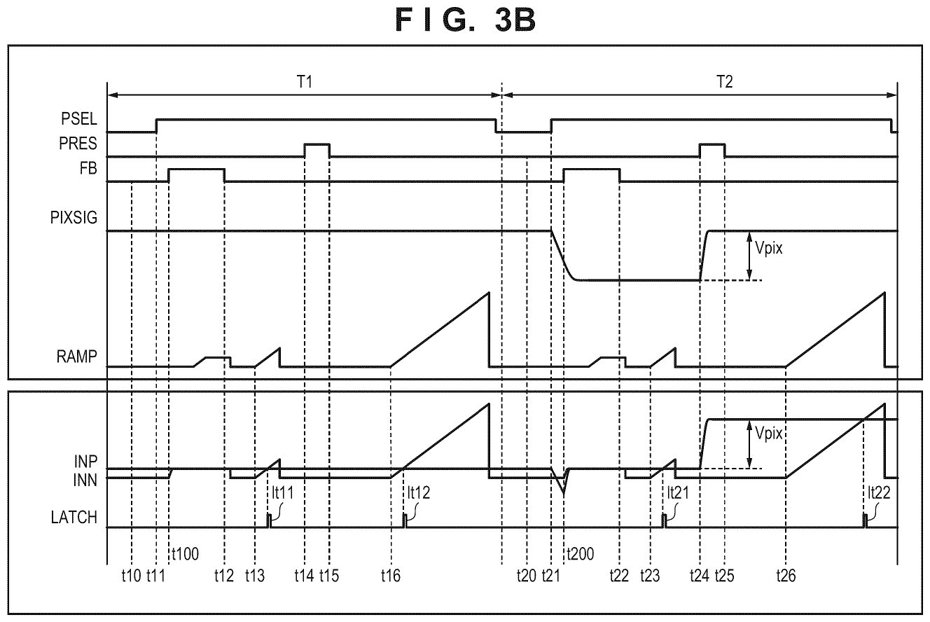

An operation example of the detection device 1 according to the first embodiment will be described below with reference to FIGS. 3A and 3B.

FIG. 3A shows the first operation example of the detection device 1 according to the first embodiment, and FIG. 3B shows the second operation example of the detection device 1 according to the first embodiment. The first operation example and the second operation example are different in terms of the timing of the signal FB. Each of FIGS. 3A and 3B shows an operation example of the pixels 100 of two rows.

A period T1 is a signal readout period of the pixels 100 of the first row (or the nth row), and a period T2 is a signal readout period of the pixels 100 of the second row (or(n+1)th row).

First, the first operation example will be described with reference to FIG. 3A. The period T1 indicates an operation in a state in which there are no accumulated electric charges in the photodiode PD of the selected pixel 100. The period T2 indicates an operation in a state in which there are accumulated electric charges in the photodiode PD of the selected pixel 100. After the operations in the periods T1 and T2, the operations in the periods T1 and T2 are performed for the selected pixel 10 of the next row, and the same operations are repeated for the subsequent rows.

The period T2 will be described first. At time t20, the timing control unit 80 sets, to high level, the signal FB supplied to each column circuit 20 of the readout circuit 110. This sets the first switch SW201 and the second switch SW202 of the A/D converter 21 in the conductive state. The signal lines INP and INN of the A/D converter 21 are reset to the voltage of the noninverting output node (O+) and the voltage of the inverting output node (O−) of the differential amplification circuit 200, respectively. The A/D converter 21 is reset to a state in which the offset voltage of the differential amplification circuit 200 is held (as the initial value) to be canceled. This allows the offset cancellation operation. For the sake of descriptive simplicity, FIGS. 3A and 3B each show the operation in a case where there is no offset voltage of the differential amplification circuit 200.

At time t21, the vertical scanning circuit 50 sets, to high level, the selection signal PSEL supplied to the selected row in the pixel array 10. This sets the selection transistors M103 of the row in the conductive state. The amplification transistor M102 of each pixel 100 of the row outputs, to the signal line 12, the signal PIXSIG having the signal level corresponding to the signal generated by the photodiode PD, that is, the potential (accumulated electric charges) of the photodiode PD. This changes the signal level of the signal PIXSIG.

At time t22, the timing control unit 80 sets, to low level, the signal FB supplied to each column circuit 20 of the readout circuit 110. This sets the first switch SW201 and the second switch SW202 of the A/D converter 21 in the nonconductive state. This means the end of the offset cancellation operation. The signal PIXSIG is supplied to the first terminal of the first capacitor C201 of each A/D converter 21. The second terminal of the first capacitor C201 of the A/D converter 21 completes holding of the voltage reset by the voltage of the inverting output node (O−) of the differential amplification circuit 200. The ramp signal RAMP is supplied to the first terminal of the second capacitor C202 of the A/D converter 21. At this time, the ramp signal generation circuit 60 sets the ramp signal RAMP to a predetermined reference voltage. The second terminal of the second capacitor C202 of the A/D converter 21 completes holding of the voltage reset at the noninverting output node (O+) of the differential amplification circuit 200. With the series of operations, it is possible to perform the offset cancellation operation of the differential amplification circuit 200 (A/D converter 21). However, noise of the A/D converter 21 such as noise generated by the OFF operation of the first switch SW201 and the second switch SW202 is superimposed on the reset voltage of the differential amplification circuit 200.

At time t23, the ramp signal generation circuit 60 starts a slope operation of the ramp signal RAMP. When the voltage (signal level) of the signal line INP and the voltage of the signal line INN become equal to each other, the differential amplification circuit 200 outputs a pulse 1t21 to the comparison result signal LATCH. Then, with the above-described A/D conversion operation, the digital signal is held in the column memory 30. This is the first A/D conversion, and it is possible to obtain the digital signal corresponding to the reset voltage of the differential amplification circuit 200 including the noise of the A/D converter 21.

At time t24, the vertical scanning circuit 50 sets the reset signal PRES to high level. This sets the reset transistor M101 in the conductive state, thereby resetting the photodiode PD. The signal PIXSIG changes to the signal level corresponding to the reset voltage of the photodiode PD.

At time t25, the vertical scanning circuit 50 sets the reset signal PRES to low level. This sets the reset transistor M101 in the nonconductive state, thereby canceling the reset of the photodiode PD. The difference (potential difference) between the signal level of the signal PIXSIG before the reset of the photodiode PD and the signal level of the signal PIXSIG after the reset of the photodiode PD, that is, the change of the signal level is a pixel signal voltage Vpix corresponding to the accumulated electric charges of the photodiode PD.

At time t26, the ramp signal generation circuit 60 starts a slope operation of the ramp signal RAMP, and performs the second A/D conversion. After the first A/D conversion, the second A/D conversion is performed for the change of the signal level of the pixel signal PIXSIG by resetting the photodiode PD by the reset transistor M101. The differential amplification circuit 200 outputs a pulse 1t22 to the comparison result signal LATCH at a timing corresponding to the value of the pixel signal voltage Vpix, and the digital signal is held in the column memory 30. By subtracting the result of the first A/D conversion from the result of the second A/D conversion, the digital signal corresponding to the pixel signal voltage Vpix, from which the noise of the A/D converter has been removed, can be obtained. The A/D converter 21 may be configured to output a value obtained by subtracting the result of the first A/D conversion from the result of the second A/D conversion.

Next, the operation in the period T1 will be described. The operation in the period T1 is different from the operation in the period T2 that there are no accumulated electric charges in the photodiode PD. Only different points will be described, and a description of the remaining operations will be omitted.

At time t11, the signal level of the signal PIXSIG remains unchanged. This is because there are no accumulated electric charges in the photodiode PD.

At time t12, the offset cancellation operation of the differential amplification circuit 200 is performed, similar to the period T2. At this time, the signal level of the signal PIXSIG depends on the accumulated electric charges of the photodiode PD. The subsequent operation is the same as in the period T2.

The second operation example shown in FIG. 3B will be described next. The second operation example shown in FIG. 3B is different from the first operation example shown in FIG. 3A only in terms of the timing of setting the signal FB to high level. The remaining timings and operations are the same and a detailed description thereof will be omitted.

The operation in the period T2 will be described. At time t20, the timing control unit 80 does not set, to high level, the signal FB supplied to each column circuit 20 of the readout circuit 110. Then, the timing control unit 80 sets the signal FB to high level at time t200. The second operation example is different from the first operation example shown in FIG. 3A in terms of this point.

At time t21, the vertical scanning circuit 50 sets the selection signal PSEL to high level. In the second operation example, the signal FB is at low level at this time, and thus the signal line INP of the A/D converter 21 is not reset. The voltage of the signal line INP changes following the signal level of the signal PIXSIG via the first capacitor C201. If the voltage variation of the signal line INP is large, an error may occur in the offset cancellation operation due to the variation of the power supply voltage VDD. In this case, an error also occurs in the result of the first A/D conversion. Therefore, as in the first operation example, it is desirable to set the signal FB to high level before the signal level of the signal PIXSIG changes.

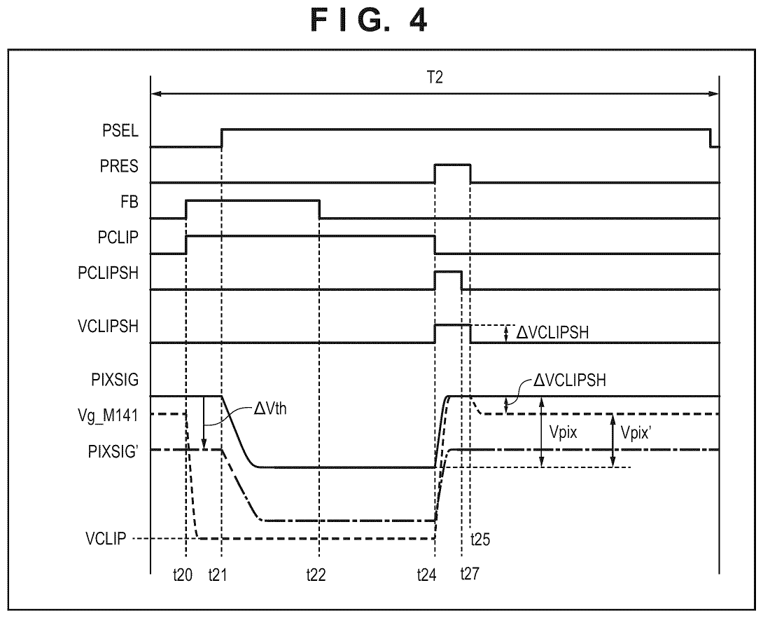

The operation of the clip circuit 140 shown in FIG. 2 will be described next with reference to FIG. 4. During the period T2 shown in FIG. 4, the same reference symbols as in the period T2 shown in FIG. 3A or 3B denote the same timings.

A voltage Vg_M141 (broken line) represents the gate voltage of the clip transistor M141 of the clip circuit 140. As described above, the clip circuit 140 clips the voltage of the signal line 12 not to be the voltage Vg_M141 or less.

At time t20, the first signal PCLIP is set to high level. The switch SW142 of the clip circuit 140 is set in the conductive state, and the voltage Vg_M141 changes to the second voltage VCLIP. The second voltage VCLIP is a voltage higher than the lower limit voltage at which the current source 130 operates.

At time t24, the first signal PCLIP is set to low level. This sets the switch SW142 of the clip circuit 140 in the nonconductive state. Next, the second signal PCLIPSH is set to high level. Then, the switch SW141 of the clip circuit 140 is set in the conductive state, and the voltage Vg_M141 changes to the signal level of the signal PIXSIG. Next, the first voltage VCLIPSH is changed to the first reference voltage.

At time t27, the second signal PCLIPSH is set to low level. Then, the switch SW141 is set in the nonconductive state, and the voltage Vg_M141 is set to a value obtained by sampling and holding the signal level of the signal PIXSIG. At time t25, the first voltage VCLIPSH is changed to the second reference voltage. The difference between the first reference voltage and the second reference voltage is a voltage ΔVCLIPSH. The voltage Vg_M141 changes to a voltage lower by the voltage ΔVCLIPSH via the capacitor C141. The voltage ΔVCLIPSH is set so that the voltage Vg_M141 is a voltage lower than the signal PIXSIG.

At time t25, the reset signal PRES is set to low level. Then, the photodiode PD is set in an accumulation state. Consider a case where the photodiode PD is irradiated with radiation during the second A/D conversion in the period T2. If the clip circuit 140 is not provided, the signal level of the signal PIXSIG changes during the second A/D conversion, and it may be impossible to perform A/D conversion corresponding to the pixel signal voltage Vpix. However, by providing the clip circuit 140, the signal level of the signal PIXSIG is clipped in accordance with the voltage Vg_M141 obtained by sampling and holding the signal level of the signal PIXSIG at time t27. Therefore, it is possible to perform A/D conversion corresponding to a voltage Vpix′. For example, the presence/absence of an electron beam may be determined for the electron beam detection application. In this case, there is no problem as long as the voltage Vpix′ has a sufficient voltage value to determine the presence/absence of an electron beam.

A signal PIXSIG′ (alternate long and short dashed line) represents a state in which a threshold shift occurs due to an electron beam in the pixel 100. This is an example by assuming a case where the signal PIXSIG′ has a voltage value lower than the voltage value of the signal PIXSIG by ΔVth due to a threshold shift of the amplification transistor M102.

The clip circuit 140 performs a clip operation based on the signal level of the signal PIXSIG′ at time t24 even in a case where the output of the pixel 100 changes like the signal PIXSIG′. Therefore, even if a threshold shift of the pixel 100 occurs, the output after the shift can be clipped appropriately.

According to the first embodiment, for example, it is possible to reduce deterioration in image quality caused by noise of the A/D converter, thereby improving the image quality.

Note that in the above-described example, the readout circuit 110 is arranged on one side of the pixel array 10. However, this is merely an example and the present invention is not limited to this. A plurality of readout circuits 110 may be provided. For example, the readout circuits 110 may be arranged on both sides of the pixel array 10. In addition, a plurality of ramp signal generation circuits 60 and a plurality of ramp signal lines 61 may be arranged. If a plurality of ramp signal generation circuits 60 and a plurality of ramp signal lines 61 are arranged, gain adjustment is performed for each of the column circuits 20 connected to the ramp signal lines 61. Gain adjustment for each of the column circuits 20 can be executed by gain adjustment in the ramp signal generation circuit 60, gain adjustment in the signal processing unit 90, gain adjustment in the external system, and the like. The switch SW201 may be connected to the second terminal of the first capacitor C201 and the node supplied with the power supply voltage, as described in Japanese Patent Laid-Open No. 2001-128070.

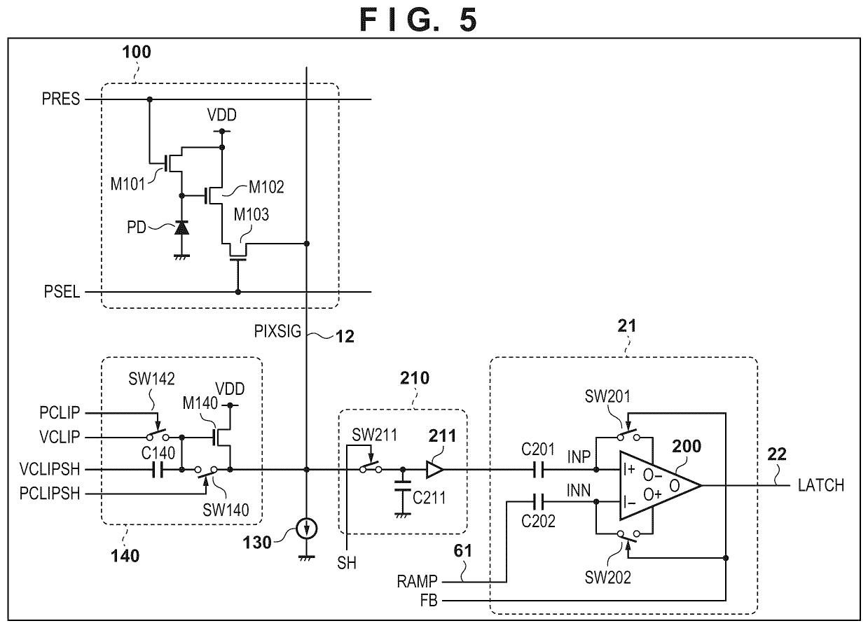

The second embodiment will be described below. Matters not mentioned as the second embodiment can comply with the first embodiment. FIG. 5 shows an example of the configuration of one pixel 100 and part of a readout circuit 110 (more specifically, a column circuit 20 connected to the pixel 100) as the configuration of a detection device 1 according to the second embodiment. In the second embodiment, the readout circuit 110 includes a sample and hold circuit 210 arranged between a signal line 12 and an A/D converter 21. The sample and hold circuit 210 can include, for example, a buffer circuit 211, a capacitor C211, and a switch SW211.

The first terminal of the capacitor C211 and the second terminal of the switch SW211 are connected to the input node of the buffer circuit 211. The output node of the buffer circuit 211 is connected to the first terminal of a first capacitor C201 of the A/D converter 21. The second terminal of the capacitor C211 is connected to a reference voltage (GND). The first terminal of the switch SW211 is connected to the signal line 12. The switch SW211 is controlled by a signal SH from a timing control unit 80. The remaining components are the same as in the first embodiment and a description thereof will be omitted.

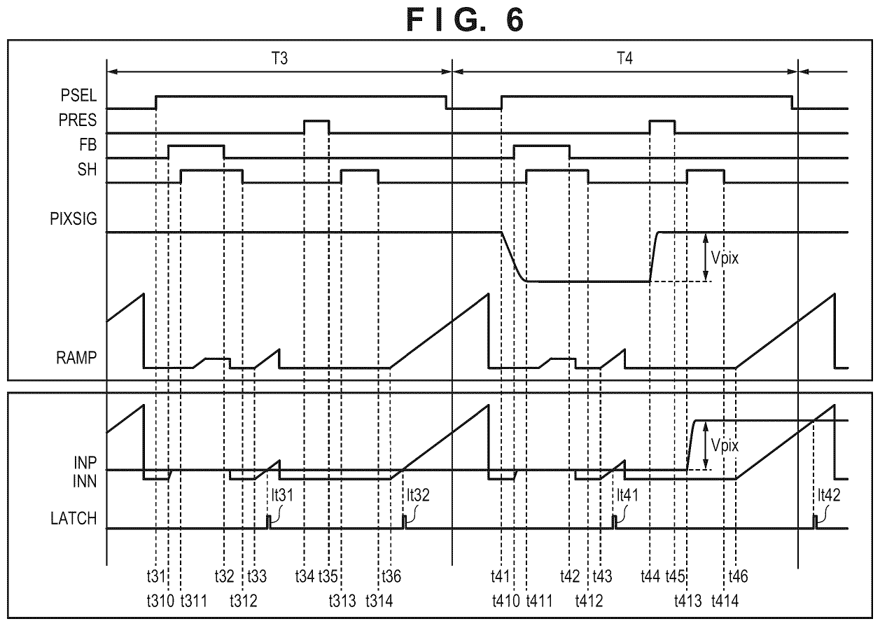

An operation example of the detection device 1 according to the second embodiment will be described below with reference to FIG. 6. The operation of the pixels 100 of two rows will be described with reference to FIG. 6. A period T3 is a signal readout period of the pixels 100 of the first row (nth row), and a period T4 is a signal readout period of the pixels 100 of the second row ((n+1)th row).

The period T3 indicates an operation in a state in which there are no accumulated electric charges in a photodiode PD of the selected pixel 100. The period T4 indicates an operation in a state in which there are accumulated electric charges in the photodiode PD of the selected pixel 100.

The operation of the sample and hold circuit 210 shown in FIG. 5 will be described with reference to the period T4 of FIG. 6. In the period T3 of FIG. 6, the same driving operation as in the period T4 is performed except for the accumulation state of the photodiode PD and a description thereof will be omitted. A description of the operation explained in the first embodiment will be omitted.

At time t41, a vertical scanning circuit 50 sets, to high level, a selection signal PSEL supplied to the selected row in a pixel array 10. Then, the signal level of a signal PIXSIG changes, similar to the first embodiment. In the second embodiment, however, the sample and hold circuit 210 is provided and thus the change of the signal PIXSIG is not transmitted to a signal line INP during a period in which a signal SH is at low level.

At time t410, the timing control unit 80 sets, to high level, a signal FB supplied to the column circuit 20. As described in the first embodiment, the signal FB is desirably set to high level before the voltage of the signal line INP changes. At time t411, the timing control unit 80 sets, to high level, the signal SH supplied to the column circuit 20 of the readout circuit 110. This sets the switch SW211 of the sample and hold circuit 210 in the conductive state, thereby sampling the signal level of the signal PIXSIG in the capacitor C211.

At time t42, the timing control unit 80 sets, to low level, the signal FB supplied to the column circuit 20 of the readout circuit 110. Then, the offset cancellation operation of a differential amplification circuit 200 (the A/D converter 21) is performed, as described in the first embodiment.

At time t412, the timing control unit 80 sets, to low level, the signal SH supplied to the column circuit 20 of the readout circuit 110. This sets the switch SW211 of the sample and hold circuit 210 in the nonconductive state, thereby holding the voltage of the signal PIXSIG in the capacitor C211.

At time t43, a ramp signal generation circuit 60 starts a slope operation of a ramp signal RAMP, thereby performing the first A/D conversion. At time t44, the vertical scanning circuit 50 sets a reset signal PRES to high level. At time t45, the vertical scanning circuit 50 sets the reset signal PRES to low level. At time t413, the timing control unit 80 sets the signal SH to high level. This samples the signal level of the signal PIXSIG in the capacitor C211. At time t414, the timing control unit 80 sets the signal SH to low level. This holds the signal level of the signal PIXSIG in the capacitor C211. At time t46, the ramp signal generation circuit 60 starts the slope operation of the ramp signal RAMP, thereby performing the second A/D conversion.

Similar to the first embodiment, it is possible to remove noise of the A/D converter 21 by subtracting the result of the first A/D conversion from the result of the second A/D conversion. The operation of a clip circuit 140 is the same as in the first embodiment and a description thereof will be omitted.

As described above, according to the second embodiment, the A/D converter 21 starts an offset cancellation operation before the signal level of the pixel signal PIXSIG is supplied to the A/D converter 21 via the sample and hold circuit 210. The A/D converter 21 starts the offset cancellation operation after a predetermined time (for example, a predetermined period is a set accumulation period) elapses since the last reset of the photodiode PD by a reset transistor M101 and before the signal level of the pixel signal PIXSIG is supplied to the A/D converter 21 via the sample and hold circuit 210.

In the second embodiment, the second A/D conversion can be overlapped with the readout operation of the pixels 100 of the next row. With reference to FIG. 6, the second A/D conversion in the period T3 is performed in the period T4. This can shorten the periods T3 and T4, thereby increasing the frame rate.

This embodiment can be used in various systems represented by the detection device 1. Such system can be, for example, a camera (imaging device) or an electron beam detection system. This system can include, for example, the detection device 1, and a processing unit configured to process an image detected using the plurality of pixels of the detection device 1.

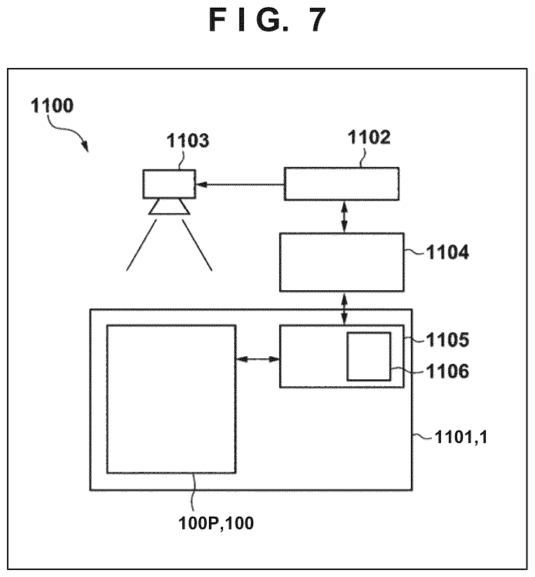

The third embodiment will be described below. Matters not mentioned as the third embodiment can comply with the first or second embodiment. FIG. 7 shows a detection system incorporating a detection device 1.

A detection system 1100 shown in FIG. 7 includes an imaging device 1101, an exposure control unit 1102, a radiation source 1103, and a computer 1104. As the imaging device 1101, the detection device 1 described in the first or second embodiment can be used.

The radiation source 1103 starts radiation irradiation in accordance with an exposure instruction from the exposure control unit 1102. Radiation emitted from the radiation source 1103 is transmitted through an imaging target (object) and enters an image sensor 1001 of the imaging device 1101. The radiation source 1103 stops emission of the radiation in accordance with a stop instruction from the exposure control unit 1102.

The imaging device 1101 is, for example, a flat panel detector used for radiation imaging in medical image diagnosis or non-destructive inspection. The imaging device 1101 includes an imaging panel 100P including the direct conversion type image sensor 1001 as a detection device. The imaging panel 100P can have a plate shape with a size matching the size of the imaging target. For example, in the image sensor 1001, 3300×2800 pixels are arranged on a substrate having a size of 550 mm×445 mm.

The imaging device 1101 includes the above-described imaging panel 100P, a control unit 1105 configured to control the imaging panel 100P, and a signal processing unit 1106 configured to process a signal output from the imaging panel 100P. The signal processing unit 1106 may be configured to perform processing of obtaining the background component of a pixel signal output from the imaging panel 100P and subtracting the background component from the pixel signal. The signal processing unit 1106 can include the function of the signal processing unit 90 of each of the first and second embodiments, and may output digital image data to the computer 1104. The signal processing unit 1106 may generate a stop signal for stopping radiation irradiation from the radiation source 1103 based on, for example, a signal output from the imaging panel 100P. The stop signal is supplied to the exposure control unit 1102 via the computer 1104, and the exposure control unit 1102 sends a stop instruction to the radiation source 1103 in response to the stop signal.

The control unit 1105 can be formed by, for example, a PLD (the abbreviation of Programmable Logic Device) such as an FPGA (the abbreviation of Field Programmable Gate Array), an ASIC (the abbreviation of Application Specific Integrated Circuit), a general-purpose computer incorporating a program, or a combination of some or all of these.

In this embodiment, the signal processing unit 1106 is arranged in the control unit 1105 or implements some functions of the control unit 1105. However, the present invention is not limited to this. The control unit 1105 and the signal processing unit 1106 may be different components. The signal processing unit 1106 may be arranged separately from the imaging device 1101. For example, the computer 1104 may have the function of the signal processing unit 1106. Therefore, the detection system 1100 can include the signal processing unit 1106 as a signal processing device for processing a signal output from the imaging device 1101.

The computer 1104 can control the imaging device 1101 and the exposure control unit 1102, and perform processing of receiving radiation image data from the imaging device 1101 and displaying the data as a radiation image. Furthermore, the computer 1104 can function as an input unit used by the user to input a condition for capturing a radiation image.

As an example, the exposure control unit 1102 includes an exposure switch. When the user turns on the exposure switch, the exposure control unit 1102 sends an exposure instruction to the radiation source 1103, and also sends a start notification indicating the start of emission of radiation to the computer 1104. Upon receiving the start notification, the computer 1104 notifies the control unit 1105 of the imaging device 1101 of the start of radiation irradiation in response to the start notification. In response to this, the control unit 1105 generates a signal corresponding to the incident radiation in the imaging panel 100P.

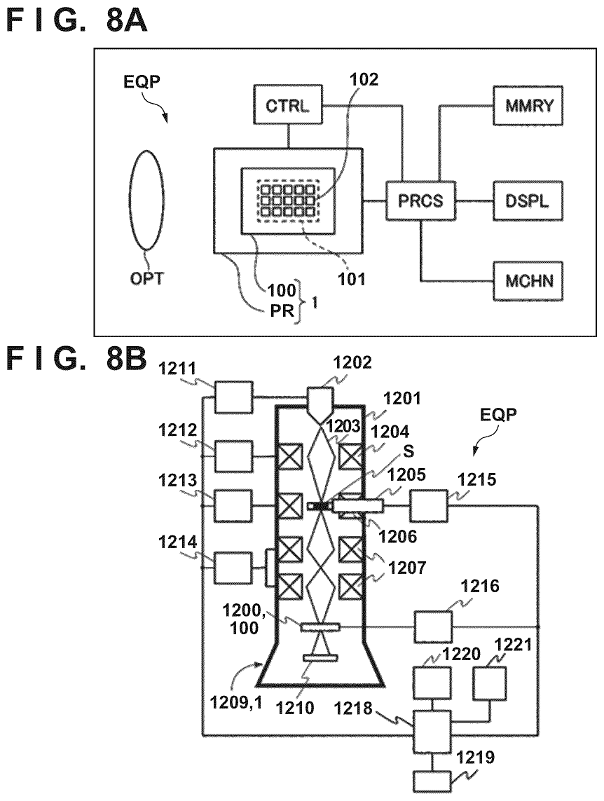

The fourth embodiment will be described below. Each of FIGS. 8A and 8B shows another example of a detection system incorporating a detection device.

FIG. 8A shows equipment EQP as a detection system including a detection device 1. The detection device 1 includes an image sensor 1001 as a semiconductor device and a package PKG for implementing the image sensor 1001.

The package PKG can include a base to which the image sensor 1001 is fixed, a lid such as glass facing the image sensor 1001, and a connecting member such as a bonding wire or bump used to connect a terminal provided on the base to a terminal provided on the image sensor 1001. The image sensor 1001 includes a pixel region 100 where pixels are arrayed in a matrix and a peripheral region PR around the pixel region 100.

The equipment EQP can further include at least one of an optical system OPT, a control device CTRL, a processing device PRCS, a display device DSPL, a storage device MMRY, and a mechanical device MCHN. The optical system OPT forms an image of radiation on the detection device 1, and is, for example, a lens, a shutter, and a mirror. The optical system OPT may form an image of a particle beam such as an electron beam or a proton beam on the detection device 1 in accordance with the kind of radiation to be processed. The control device CTRL controls the detection device 1, and is, for example, an ASIC. The processing device PRCS processes a signal output from the detection device 1, and is, for example, a device such as a CPU or an ASIC for forming an Analog Front End (AFE) or a Digital Front End (DFE). The display device DSPL is an EL display device or a liquid crystal display device that displays, in a format such as a visible image, information obtained by the detection device 1. The storage device MMRY is a magnetic device or a semiconductor device for storing information obtained by the detection device 1. The storage device MMRY is a volatile memory such as an SRAM or a DRAM or a nonvolatile memory such as a flash memory or a hard disk drive. The mechanical device MCHN includes a moving or propulsion unit such as a motor or an engine.

In the equipment EQP, a signal output from the detection device 1 is displayed on the display device DSPL, or transmitted to an external device by a communication device (not shown) included in the equipment EQP. Hence, the equipment EQP preferably further includes the storage device MMRY and the processing device PRCS in addition to a storage circuit and an arithmetic circuit included in the detection device 1. The mechanical device MCHN may be controlled based on the signal output from the detection device 1.

The equipment EQP shown in FIG. 8A may be medical equipment such as an endoscope or radiation diagnosis equipment, measurement equipment such as a distance measurement sensor, or analysis equipment such as an electron microscope.

FIG. 8B is a schematic view showing the configuration of a Transmission Electron Microscope (TEM) as an example of the equipment EQP. The equipment EQP serving as an electron microscope includes an electron beam source 1202 (electron gun), an irradiation lens 1204, a vacuum chamber 1201 (lens barrel), an object lens 1206, a magnifying lens system 1207, and a camera 1209 serving as the detection device 1.

An electron beam 1203 as an energy beam emitted from the electron beam source 1202 is focused by the irradiation lens 1204, and irradiates a sample S as an analysis target held by a sample holder. A space through which the electron beam 1203 passes is formed by the vacuum chamber 1201 (lens barrel), and is held in vacuum. The detection device 1 is arranged to face the vacuum space through which the electron beam 1203 passes. The electron beam 1203 transmitted through the sample S is magnified by the object lens 1206 and the magnifying lens system 1207, and projected to the detection device 1. An electron optical system for irradiating the sample S with an electron beam is called an irradiation optical system, and an electron optical system for forming an image of the electron beam transmitted through the sample S on the detection device 1 is called an imaging optical system.

The electron beam source 1202 is controlled by an electron beam source control device 1211. The irradiation lens 1204 is controlled by an irradiation lens control device 1212. The object lens 1206 is controlled by an object lens control device 1213. The magnifying lens system 1207 is controlled by a magnifying lens system control device 1214. A control mechanism 1205 of the sample holder is controlled by a holder control device 1215 configured to control a driving mechanism of the sample holder.

The electron beam 1203 transmitted through the sample S is detected by a direct electron detector 1200 of the camera 1209. A signal output from the direct electron detector 1200 is processed by a signal processing device 1216 and an image processing device 1218 serving as the processing device PRCS, thereby generating an image signal. The generated image signal (transmission electron image) is displayed on an image display monitor 1220 and an analysis monitor 1221 corresponding to the display device DSPL.

The camera 1209 is provided in the lower portion of the equipment EQP. The camera 1209 includes the direct electron detector 1200. The direct electron detector 1200 corresponds to the image sensor 1001. At least part of the camera 1209 is provided in the camera 1209 so as to be exposed to the vacuum space formed by the vacuum chamber 1201.

Each of the electron beam source control device 1211, the irradiation lens control device 1212, the object lens control device 1213, the magnifying lens system control device 1214, and the holder control device 1215 is connected to the image processing device 1218. This allows them to exchange data in order to set the imaging condition of the electron microscope. For example, an electron beam irradiation rate can be set to be 0.5 electron/pix/frm or less. In this case, the electron beam source control device 1211 and the image processing device 1218 function as a control means for controlling a radiation irradiation rate. By a signal from the image processing device 1218, driving control of the sample holder and setting of the observation condition of each lens can be performed.

An operator prepares the sample S as an imaging target, and sets imaging conditions using an input device 1219 connected to the image processing device 1218. Predetermined data is input to each of the electron beam source control device 1211, the irradiation lens control device 1212, the object lens control device 1213, and the magnifying lens system control device 1214 to obtain a desired acceleration voltage, magnification, and observation mode. Furthermore, the operator inputs conditions such as the number of continuous visual field images, an imaging start position, and the moving speed of the sample holder to the image processing device 1218 using the input device 1219 such as a mouse, a keyboard, and a touch panel. The image processing device 1218 may automatically set the conditions regardless of the operator input.

The detection system described in each of the third and fourth embodiments is merely an example, and the detection device described in each of the first and second embodiments may be applied to another system.

According to the present invention, there is provided a technique advantageous in detecting, with low noise, a signal generated by a pixel.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-006213, filed Jan. 18, 2024, which is hereby incorporated by reference herein in its entirety.

What is claimed is:

1. A detection device comprising:
a pixel including a photodiode, an amplification transistor having a gate connected to an output node of the photodiode, a reset transistor configured to reset the photodiode, and a selection transistor;
a signal line connected to the pixel; and
a readout circuit configured to read out a signal from the pixel via the signal line,
wherein the readout circuit includes an A/D converter configured to A/D-convert the signal input from the pixel via the signal line, and
the A/D converter performs an offset cancellation operation of holding a signal level corresponding to a signal generated by the photodiode while canceling an offset of the A/D converter, and performs first A/D conversion for a change of the signal level obtained after the offset cancellation operation.

2. The device according to claim 1, wherein the A/D converter performs, after the first A/D conversion, second A/D conversion for the change of the signal level by resetting the photodiode by the reset transistor.

3. The device according to claim 1, wherein the A/D converter starts the offset cancellation operation before the signal level is supplied to the A/D converter.

4. The device according to claim 1, wherein the A/D converter starts the offset cancellation operation after a predetermined time elapses since a last reset of the photodiode by the reset transistor and before the signal level is supplied to the A/D converter.

5. The device according to claim 1, wherein the readout circuit further includes a sample and hold circuit arranged between the signal line and the A/D converter.

6. The device according to claim 5, wherein the A/D converter starts the offset cancellation operation before the signal level is supplied to the A/D converter via the sample and hold circuit.

7. The device according to claim 5, wherein the A/D converter starts the offset cancellation operation after a predetermined time elapses since a last reset of the photodiode by the reset transistor and before the signal level is supplied to the A/D converter via the sample and hold circuit.

8. The device according to claim 3, wherein the A/D converter includes
a differential amplification circuit including a first input node given with the signal level, a second input node given with a ramp signal, a first output node in phase with the first input node, and a second output node in phase with the second input node,
a first capacitor arranged between the signal line and the first input node,
a second capacitor arranged between the signal line and the second input node,
a first switch configured to short-circuit the first input node and the second output node, and
a second switch configured to short-circuit the second input node and the first output node.

9. The device according to claim 8, wherein the offset cancellation operation is an operation of setting the first switch and the second switch in a nonconductive state after setting the first switch and the second switch in a conductive state.

10. The device according to claim 9, wherein the offset cancellation operation is started by setting the first switch and the second switch in the conductive state.

11. The device according to claim 10, wherein the offset cancellation operation is ended by changing the first switch and the second switch from the conductive state to the nonconductive state.

12. The device according to claim 8, wherein
the first input node is a noninverting input node,
the second input node is an inverting input node,
the first output node is a noninverting output node, and
the second output node is an inverting output node.

13. The device according to claim 1, wherein the photodiode detects ionizing radiation.

14. The device according to claim 13, wherein the readout circuit further includes a clip circuit configured to clip a voltage of the signal line.

15. The device according to claim 14, wherein the clip circuit clips the voltage of the signal line in accordance with a voltage obtained by sampling and holding the voltage of the signal line.

16. A detection device comprising:
a pixel including a photodiode configured to receive radiation, an amplification transistor having a gate connected to an output node of the photodiode, a reset transistor configured to reset the photodiode, and a selection transistor;
a signal line connected to the pixel; and
a readout circuit configured to read out a signal from the pixel via the signal line,
wherein the readout circuit includes an A/D converter configured to A/D-convert the signal input from the pixel via the signal line,
the A/D converter includes a differential amplification circuit including an input node and an output node, a capacitive element having one terminal connected to the input node and the other terminal connected to the signal line, and a switch connected to the one terminal,
the switch transitions from an ON state to an OFF state during a period in which a first signal having a signal level corresponding to a dose of the radiation received by the photodiode is output to the one terminal,
a second signal having a signal level corresponding to a reset level of the gate is output to the one terminal during a period until the switch changes from the OFF state to the ON state again, and
the A/D converter performs A/D conversion during a period in which the second signal is output to the one terminal.

17. The device according to claim 16, wherein the switch is a switch configured to connect the one terminal to the output node.

18. The device according to claim 16, wherein the switch is a switch configured to connect the one terminal to a node supplied with a power supply voltage.

19. The device according to claim 16, wherein
a plurality of pixels arranged in a plurality of rows are provided,
the switch transitions from the ON state to the OFF state after the selection transistor of the pixel arranged on a first row transitions from an OFF state to an ON state, and
during a period before the selection transistor transitions from the ON state to the OFF state, the reset transistor transitions from an ON state to an OFF state after transitioning from the OFF state to the ON state, and the A/D conversion is performed.

20. A detection system comprising:
a radiation source configured to irradiate an imaging target with radiation;
a detection device defined in claim 1; and
a processing unit configured to process an image detected using a plurality of pixels of the detection device.
